(19) United States
(12) Patent Application Publication
(10) Pub. No.: US 2019/0301179 A1
(43) Pub. Date: Oct. 3, 2019

(54) SLIP PROOF TILE HAVING A RUBBER LAYER AS A BOTTOM LAYER

(71) Applicant: Dongguan Mei Jer Plastic Products Co., Ltd., Dongguan City (CN)

(72) Inventor: Pen-Yuan CHEN, New Taipei City (TW)

(21) Appl. No.: 15/968,016

(22) Filed: May 1, 2018

(30) Foreign Application Priority Data
Mar. 30, 2018 (CN) 201810293322.8

(51) Int. Cl. E04F 15/10; B32B 7/12; B32B 25/08; B32B 25/04; B32B 27/30; E04F 15/02

(52) U.S. Cl. CPC E04F 15/107; B32B 7/12; B32B 25/08; B32B 25/042; B32B 27/304; E04F 2290/043; B32B 2250/04; B32B 2307/744; B32B 2419/04; E04F 15/02177; E04F 15/0215

(57) ABSTRACT

A slip proof tile having a rubber layer as its bottom layer is disclosed. The rubber layer is disposed as a bottom layer of the tile, and the rubber layer comprises raw materials made of natural rubber, EVA mixture, calcium carbonate, stearic acid, Zinc oxide, cross linking agent and foaming agent. By employing the proposed present invention, the slip proof tile is advantageous of providing high slip resistance and meanwhile preventing from being moved or falling off.

This application claims priority for China patent application no. 201810293322.8 filed on Mar. 30, 2018, the content of which is incorporated by reference in its entirety.

### BACKGROUND OF THE INVENTION

### Field of the Invention

The present invention relates to a slip proof tile, and more particularly to a slip proof tile which comprises a rubber layer as its bottom layer.

### Description of the Prior Art

As everyone knows, resin materials i.e. macromolecular compounds for paving floors are utilized for fabricating plastic tiles, which comprises the following advantages: (1) reasonable prices—that are much cheaper than prices of carpets, wooden floors, building stones, and ceramics paving materials; (2) fine appearances—since plastic tiles have a large variety of species, patterns, colors, textures, shapes and are equipped with surfaces having high density structures, different needs and specifications of certain groups of people can be satisfied. For instance, wood grains and patterns for marbles, carpets and granites can all be made artificially through the plastic tiles and are quite realistic; (3) great functionality—providing foot comfortableness and warmth for users as well as isolating from heat, noise and humidity; (4) simple paving process—without using any cements and grits, it simply requires setting adhesives for paving thereby being much easier and more convenient than before. Also, consumers can participate in selecting the materials, paving styles and methods for their plastic tiling floor; (5) light weight—being ten times lighter than that of a wooden floor, 20 times lighter than that of a ceramic floor, and 25 times lighter than that of a stone-made floor, whereby are appropriate for three or even more storied high buildings or office buildings in order to ease its weight for better safety assurance and easier porterage; and (6) easy maintenances for cleaning, drying as well as grinding so as to have a longer lifetime. Based on the above mentioned merits, it is apparent that plastic tiles can not only be much more advantageous than conventional materials but also be widely utilized in all kinds of fields.

However, in a traditional way to pave the plastic tiling floors, white glue is always applied first. Thereafter, provide primer to fill in the floor, and setting adhesives are then applied on a back side of each tile. As such, the tiles can be adhered to the flat ground. Nevertheless, by employing the traditional method, the paving process always takes too much time and requires high complexity. Moreover, due to the setting adhesives, the tiles cannot be repeatedly utilized. In order to solve the problems, a certain type of glue/adhesives-free tiles are proposed, which are provided with slip proof patterns on a bottom surface of the plastic tile which are in contact with the ground. Although the slip proof patterns have enough diversifications, they cannot be used practically—still having quite low slip resistances. Apart from these, another certain type of snap-fit tiles are also proposed, nevertheless having even worse slip resistances than the glue/adhesives types due to its terrible slip resistances at bottom surface.

Therefore, on account of above, to overcome the abovementioned problem, it should be obvious that there is indeed an urgent need for the professionals in the field for a novel slip proof tile to be developed that can effectively solve those above mentioned problem occurring in the prior design.

### SUMMARY OF THE INVENTION

In order to overcome the above mentioned disadvantages that a conventional tile usually lacks for slip resistances as well as a conventional tile cannot be repeatedly used due to setting adhesives, the present invention is provided for a slip proof tile having a rubber layer as its bottom layer. By disposing such a rubber layer at bottom of the tile, an excellent slip resistance can effectively be accomplished.

For achieving the abovementioned objectives, the present invention provides a slip proof tile having a rubber layer as a bottom layer. The slip proof tile comprises a foundation layer, an adhesive layer and a rubber layer. The foundation layer includes a top surface and a bottom surface. The adhesive layer is disposed on the bottom surface of the foundation layer, and the rubber layer is integrated to the bottom surface of the foundation layer through the adhesive layer such that the tile can be firmly disposed on the ground without slipping and/or moving due to the rubber layer at bottom. According to one embodiment of the present invention, the rubber layer is made of raw materials, comprising natural rubber, EVA mixture, calcium carbonate, stearic acid, Zinc oxide, cross linking agent, and foaming agent.

According to the embodiment of the present invention, the rubber layer comprises raw materials which are made of 74-78% by weight ratio of natural rubber, 9-12% by weight ratio of EVA mixture, 8-10% by weight ratio of calcium carbonate, 0.4-0.5% by weight ratio of stearic acid, 0.9-1.1% by weight ratio of Zinc oxide, 0.4-0.5% by weight ratio of cross linking agent, and 1.5-1.9% by weight ratio of foaming agent.

According to one embodiment of the present invention, the slip proof tile further comprises a printing layer, being disposed on the top surface of the foundation layer.

According to one embodiment of the present invention, the slip proof tile further comprises a grinding layer, being disposed on the printing layer.

According to one embodiment of the present invention, a thickness of the rubber layer is 1-25 mm.

In one embodiment, the EVA mixture is composed of 20% by weight ratio of Ethylene-vinyl acetate copolymer, 35% by weight ratio of Block polyolefin, and 45% by weight ratio of Ethylene/propylene copolymer. The stearic acid is a mixture of 1-pentadecane carboxylic acid and 1-heptadecane carboxylic acid. The foaming agent can be azodicarbonamide. And, the cross linking agent is Di (tert-butyl peroxyisopropyl) benzene.

Moreover, according to one embodiment of the present invention, the foundation layer can be made of plastic or rubber.

As a result, by employing the above mentioned slip proof tile of the present invention, a rubber layer is disposed as a bottom layer as well as a slip proof layer of the tile. As such, the tile is able to be firmly disposed on the ground without slipping and/or moving around, and an extremely high slip resistance is therefore accomplished.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 shows a flow chart of fabricating a rubber layer by using the raw materials according to one embodiment of the present invention.

FIG. 2 shows a cross sectional view of a slip proof tile having a rubber layer as a bottom layer according to one embodiment of the present invention.

FIG. 3 shows a cross sectional view of a slip proof tile having a rubber layer as a bottom layer according to another embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The embodiments described below are illustrated to demonstrate the technical contents and characteristics of the present invention and to enable the persons skilled in the art to understand, make, and use the present invention. However, it shall be noticed that, it is not intended to limit the scope of the present invention. Therefore, any equivalent modification or variation according to the spirit of the present invention is to be also included within the scope of the present invention.

According to one embodiment of the present invention, a rubber layer comprises raw materials which are made of 74-78% by weight ratio of natural rubber, 9-12% by weight ratio of EVA mixture, 8-10% by weight ratio of calcium carbonate, 0.4-0.5% by weight ratio of stearic acid, 0.9-1.1% by weight ratio of Zinc oxide, 0.4-0.5% by weight ratio of cross linking agent, and 1.5-1.9% by weight ratio of foaming agent.

To be more specific, the EVA mixture is further composed of 20% by weight ratio of Ethylene-vinyl acetate copolymer, 35% by weight ratio of Block polyolefin, and 45% by weight ratio of Ethylene/propylene copolymer. The stearic acid is a mixture of 1-pentadecane carboxylic acid and 1-heptadecane carboxylic acid. The foaming agent can be azodicarbonamide. And, the cross linking agent is Di (tert-butyl peroxyisopropyl) benzene.

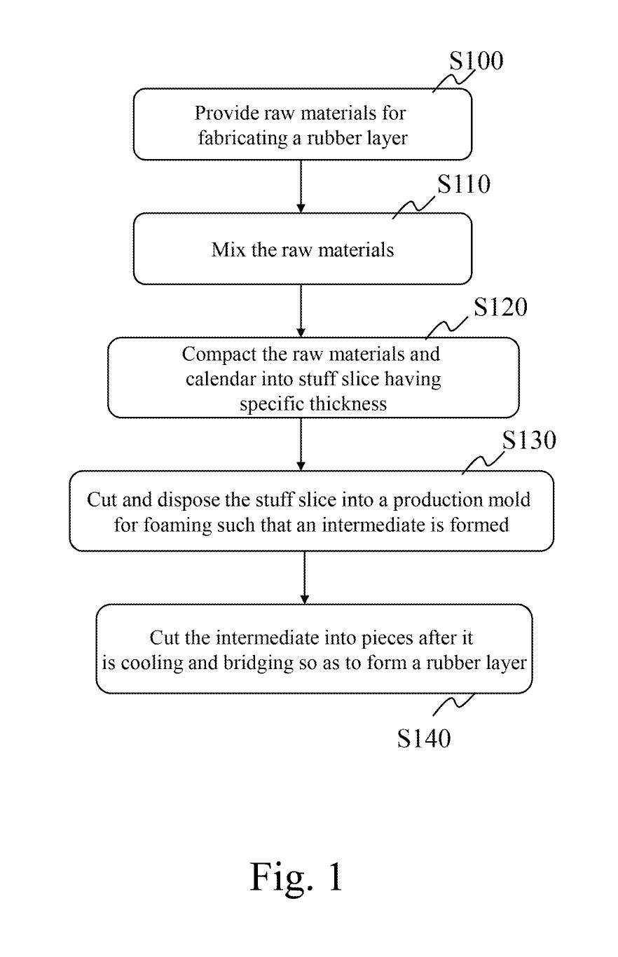

Please refer to FIG. 1, which shows a flow chart of fabricating a rubber layer by using the above mentioned raw materials according to one embodiment of the present invention.

At first, as shown in step S100, the present invention provides raw materials which are made of 76% by weight ratio of natural rubber, 11.4% by weight ratio of EVA mixture, 9% by weight ratio of calcium carbonate, 0.43% by weight ratio of stearic acid, 1.03% by weight ratio of Zinc oxide, 0.44% by weight ratio of cross linking agent, and 1.7% by weight ratio of foaming agent for fabricating a rubber layer.

In detailed, the EVA mixture is further composed of 20% by weight ratio of Ethylene-vinyl acetate copolymer, 35% by weight ratio of Block polyolefin, and 45% by weight ratio of Ethylene/propylene copolymer. The stearic acid is a mixture of 1-pentadecane carboxylic acid and 1-heptadecane carboxylic acid. The foaming agent can be azodicarbonamide. And, the cross linking agent is Di (tert-butyl peroxyisopropyl) benzene.

Later, as shown in step S110, mix the raw materials by a masticating mixer under a temperature of 95-115° C. for 15 minutes.

Then as shown in step S120, after the raw materials are mixed, use a wheel machine for compacting the raw materials in better uniformity. The operating temperature is 60-70° C., and the operating time is 3-5 minutes. After the raw materials are compacted and united repeatedly through the wheel machine, a calendaring machine is then utilized to press out a stuff slice having specific thickness.

Later, as shown in step S130, the stuff slice is weighted according to its specification and density, cut and disposed into a production mold, in which a hydraulic machinery is utilized for foaming According to the embodiment of the present invention, the foaming process is performed under an operating temperature being 175° C. for 30 minutes. When it is finished, an intermediate is formed.

At last, as shown in step S140, after the intermediate is cooling and bridging for a certain period of time, the intermediate can alternatively be cut into pieces based on demanding thickness so as to form a white rubber layer. According to one embodiment of the present invention, the white rubber layer can be used for adhering to a floor tile. For example, the intermediate can be cut into pieces so as to form the rubber layer having thickness of 1-25 mm.

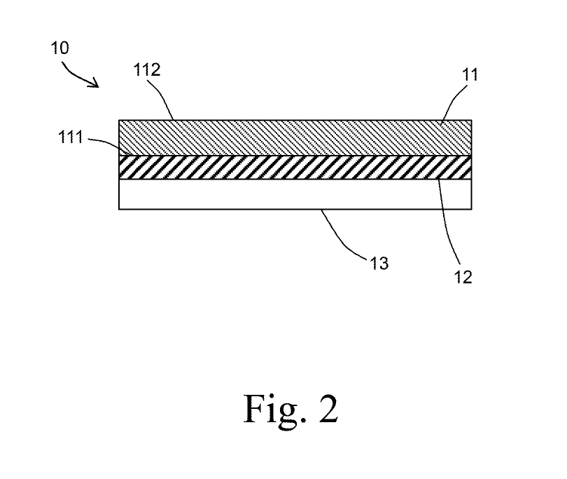

In the following, the present invention discloses using the proposed rubber layer as a bottom layer of a slip roof tile in an objective for preventing slipping. Please refer to FIG. 2, which shows a cross sectional view of a slip proof tile 10 having a rubber layer as a bottom layer according to one embodiment of the present invention.

According to one embodiment of the present invention, the slip proof tile 10 comprises a foundation layer 11, an adhesive layer 12 and a rubber layer 13 from top to bottom, which are thermally composited. The foundation layer 11 can be made of plastic, rubber, wood or building stone. In the present embodiment, the foundation layer 11 is made of PVC (PolyVinyl Chloride) due to its high stability and less distortion affected by the environmental temperatures. The adhesive layer 12 is disposed on a bottom surface 111 of the foundation layer 11, so the rubber layer 13 is integrated to the bottom surface 111 of the foundation layer 11 through the adhesive layer 12. Furthermore, the rubber layer 13 is made of the raw materials, which are composed of weight ratios as above mentioned. Therefore the rubber layer 13 is characterized by having extremely high slip resistance. As a result, through the rubber layer 13, the foundation layer 11 can be firmly disposed on the ground without slipping and/or moving. In the meantime, the rubber layer 13 is designed to be also capable of absorbing noise. As such, when objects are moved on the slip proof tile 10 having the rubber layer as its bottom layer, the noise being made can be effectively absorbed by the rubber layer 13 thereby maintaining superior silence.

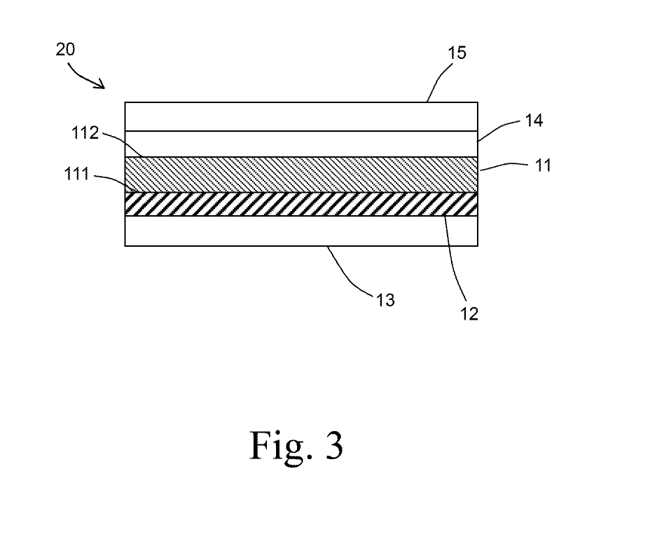

Moreover, please refer to FIG. 3, which shows a cross sectional view of a slip proof tile 20 having a rubber layer as a bottom layer according to another embodiment of the present invention.

According to another embodiment of the present invention, what makes the slip proof tile 20 differ from the slip proof tile 10 as previously disclosed in the earlier embodiment is that the slip proof tile 20 further comprises a printing layer 14 on a top surface 112 of the foundation layer 11, and a grinding layer 15 on the printing layer 14. In such an embodiment, the slip proof tile 20 is further advantageous of providing fine appearance and grinding effect. For example, the printing layer 14 and the grinding layer 15 can be made of PVC (PolyVinyl Chloride).

Furthermore, a push-and-pull method is adopted to examine static coefficient of friction of the slip proof tile of the present invention as well as the conventional tile in order to compare their slip proof efficiency. The testing results are provided as Table 1 in the following, under the testing condition having sample size=76 mm*76 mm*3.0 mm (for the conventional tile), 76 mm*76 mm*4.8 mm (for the present invention); area in contact=76*76(mm²); and carry weight=23.8 kg.

TABLE 1

| Testing item | the present invention | the conventional tile |
|---|---|---|
| static coefficient | 0.72 | 0.56 |
| of friction (dried) | | |
| static coefficient | 0.77 | 0.68 |
| of friction (wet) | | |

From the testing results, it is proved that the slip resistance of the slip proof tile having the rubber layer as its bottom layer of the present invention is much better than that of a traditional coating tile or comb tile. As compared, it is apparent that through the rubber layer, the slip proof tile having the rubber layer as its bottom layer of the present invention is able to be firmly disposed on the ground without slipping and/or moving. And, its slip proof efficiency, the adhering and absorbing effects are thus much more improved as well.

In conclusion, according to the slip proof tile having the rubber layer as its bottom layer of the present invention, since the rubber layer can be used for providing better slip resistance and silence effect, the tile is able to be firmly disposed on the ground without slipping and/or moving around. Also, when people are walking on the tiles or any objects are moved on the tiles, the noise being made can be absorbed and eliminated. As a result, the proposed tile is especially appropriate for being paved in occasions requiring tranquilization, such as hospitals, libraries, bedrooms, or recording studios. In addition, since the components and the fabricating process as well as its cost of the proposed tile of the present invention are quite simple, safe and inexpensive, the slip proof tile of the present invention with no doubts, can be widely utilized in all kinds of fields as a popular and ideal product for floor tile paving.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A slip proof tile having rubber layer as a bottom layer, comprising:
a foundation layer, having a top surface and a bottom surface;
an adhesive layer, disposed on the bottom surface of the foundation layer; and
a rubber layer, being integrated to the bottom surface of the foundation layer through the adhesive layer, wherein the rubber layer is made of raw materials, comprising:
(a) natural rubber;
(b) EVA mixture;
(c) calcium carbonate;
(d) stearic acid;
(e) Zinc oxide;
(f) cross linking agent; and
(g) foaming agent.

2. The slip proof tile having rubber layer as a bottom layer according to claim 1, further comprising:
a printing layer, being disposed on the top surface of the foundation layer.

3. The slip proof tile having rubber layer as a bottom layer according to claim 2, further comprising:
a grinding layer, being disposed on the printing layer.

4. The slip proof tile having rubber layer as a bottom layer according to claim 1, wherein a thickness of the rubber layer is 1-25 mm.

5. The slip proof tile having rubber layer as a bottom layer according to claim 1, wherein the rubber layer comprises the raw materials which are made of 74-78% by weight ratio of natural rubber, 9-12% by weight ratio of EVA mixture, 8-10% by weight ratio of calcium carbonate, 0.4-0.5% by weight ratio of stearic acid, 0.9-1.1% by weight ratio of Zinc oxide, 0.4-0.5% by weight ratio of cross linking agent, and 1.5-1.9% by weight ratio of foaming agent.

6. The slip proof tile having rubber layer as a bottom layer according to claim 5, wherein the rubber layer comprises the raw materials which are made of 76% by weight ratio of natural rubber, 11.4% by weight ratio of EVA mixture, 9% by weight ratio of calcium carbonate, 0.43% by weight ratio of stearic acid, 1.03% by weight ratio of Zinc oxide, 0.44% by weight ratio of cross linking agent, and 1.7% by weight ratio of foaming agent.

7. The slip proof tile having rubber layer as a bottom layer according to claim 1, wherein the EVA mixture is composed of 20% by weight ratio of Ethylene-vinyl acetate copolymer, 35% by weight ratio of Block polyolefin, and 45% by weight ratio of Ethylene/propylene copolymer.

8. The slip proof tile having rubber layer as a bottom layer according to claim 1, wherein the stearic acid is a mixture of 1-pentadecane carboxylic acid and 1-heptadecane carboxylic acid, and the foaming agent is azodicarbonamide.

9. The slip proof tile having rubber layer as a bottom layer according to claim 1, wherein the cross linking agent is Di (tert-butyl peroxyisopropyl) benzene.

10. The slip proof tile having rubber layer as a bottom layer according to claim 1, wherein the foundation layer is made of plastic or rubber.
